(19) United States
(12) Patent Application Publication
(10) Pub. No.: US 2024/0370855 A1
(43) Pub. Date: Nov. 7, 2024

(54) System and method for sharing network connectivity in a simulated environment

(71) Applicant: Bank of America Corporation, Charlotte, NC (US)

(72) Inventor: Shailendra Singh, Maharashtra (IN)

(21) Appl. No.: 18/311,801

(22) Filed: May 3, 2023

(51) Int. Cl. G06Q 20/36; G06Q 20/38

(52) U.S. Cl. CPC G06Q 20/3676; G06Q 20/389

(57) ABSTRACT

An apparatus may comprise a memory communicatively coupled to a processor. The memory may be configured to store a validation profile and service access provider information. The processor may be configured to generate a service token indicating service provider access information for a digital entity in a virtual environment; enable access to at least one service in the service provider via the service token; transmit the service token to the digital entity in the virtual environment; and share the access to the at least one service with the digital entity. Further, the processor may be configured to monitor a value of a token parameter associated with the digital entity in the virtual environment and, in response to determining that the value of the token parameter is outside a predefined threshold range, disable the access to the at least one service in the service provider via the service token.

### TECHNICAL FIELD

The present disclosure relates generally to operation of a system configured to provide access to one or more services in a simulated (e.g., virtual) environment, and more specifically to a system and a method to share network connectivity in a simulated environment.

### BACKGROUND

In a network environment, user devices located at different locations may use different types of services to connect to a network. Each user device may have a specific service provider arrangement that enables a predefined bandwidth and a predefined connection speed to access the network. In this regard, each user device may be configured to only access the network using the corresponding predefined bandwidth and predefined connection speed. As a result, user devices with smaller predefined bandwidths tend to have access to fewer network resources than user devices with larger predefined bandwidths.

For example, a first user device with a first service provider arrangement that enables a first predefined bandwidth of 2 gigabytes (GB) and a first predefined connection speed of 300 megabits per second (Mbps) may have access to more network resources than a second user device with a second service provider arrangement that enables a second predefined bandwidth of 1 GB and a first predefined connection speed of 25 Mbps.

### SUMMARY OF THE DISCLOSURE

In one or more embodiments, a system and a method disclosed herein share network connectivity in a simulated (e.g., virtual) environment. The system and the method may be configured to receive requests from one or more digital entities in the virtual environment. The requests may be to obtain one or more services from a service provider. The system and the method may parse each request and retrieve a validation profile associated with each of the one or more digital entities. The system and the method may determine whether a specific validation profile is sufficient to confirm an identity of a specific user device. Upon confirming the identity of a given user device, the method and the system generate a service token indicating a service provider access information to the digital entity in the virtual environment. The digital entity may use the service provider access information to access the service from the service provider. In some embodiments, the service may comprise a new bandwidth allocation and a new connection speed between a user device associated with the digital entity in the real world. In this regard, the service provider access information enables the user device associated with the digital entity to use the service provider to access the service specified in the token. In other embodiments, the token may include multiple token parameters that act as restrictions to the access of the service. In one or more parameters, the token parameters may comprise a time restriction information that limits a duration of the token and a proximity restriction that limits access to the service via the token to an area or a session in the virtual environment that is in a predefined proximity range to a digital entity sharing the token.

In one or more embodiments, the system and the method described herein are integrated into a practical application of sharing bandwidth allocation. Further, the system and the method are integrated into a practical application of slicing up bandwidth allocated for a user device with a service provider and providing access to one or more slices to one or more additional user devices. For example, the user device may have a service provider agreement with the service provider to access a bandwidth of 2 gigabytes (GBs). The user device may slice the 2 GB into four slices, each slice comprising 0.5 GBs (e.g., 500 megabytes (MBs)). Then, the user device may share a first slice of 0.5 GB to a first additional user device and a second slice of 0.5 GBs to a second additional user device while maintaining two slices of 0.5 GBs in use. In some embodiments, the user device may generate additional slices from an existing slice. In the aforementioned example, the user device may further device a third slice of 0.5 GBs into five separate slices of 0.1 GB (e.g., 100 MBs).

In some embodiments, the system and the method are integrated into a practical application of bandwidth allocation in the virtual environment. In particular, the system and the method may share the bandwidth slices in the virtual environment with the additional user devices. In this regard, the system and the method provide the practical application of enabling or disabling access to bandwidth slices while maintaining operations in the virtual environment. As a non-limiting example of technical solutions involving this practical application, the system and the method allow the user device to maintain immersive operations and experiences in the virtual environment because the user device shares the bandwidth slices via a corresponding digital entity of a user to digital entities of additional users in the virtual environment.

In one or more embodiments, the system and method are directed to improvements in computer systems. Specifically, the system and the method reduce processor and memory usage in user devices and servers by reducing or eliminating operations related to handling and assigning bandwidth slices to multiple users. In particular, the system and the method reduce or eliminate processing times and memory usage associated with slicing a specific bandwidth and establishing a new service agreement with a common service provider. Instead, the system and the method perform any handling and slicing operations between the user device and the service provider such that additional service agreements are not implemented between the additional user devices and the service provider. Substantial processing capacity, memory usage, and power consumption is prevented by dynamically slicing and sharing bandwidth slices with the additional user devices while maintaining the original service agreement between the user device and the service provider. Another technical solution involves eliminating potential great numbers of human work hours attempting to create new service agreements each time a user device attempts to share some of the corresponding bandwidth.

In one or more embodiments, the system and the method may be performed by an apparatus, such as a playback device, communicatively coupled to a server and one or more user devices. Further, the system may be a system that comprises the apparatus. In addition, the system and the method may be performed as part of a process performed by the apparatus communicatively coupled to the server. The method may be further implemented in a non-transitory computer readable medium storing instructions that when executed by a processor cause the processor to perform operations in according to the method. As a non-limiting example, the apparatus may comprise a memory and a processor communicatively coupled to one another. The memory may be configured to store at least one user profile indicating at least one credential associated with accessing a virtual environment and service access provider information indicating instructions to access one or more services from a service provider. The processor may be configured to transmit a validation profile to a registry in which each credential of multiple credentials is confirmed as belonging to a digital entity in the virtual environment. The digital entity may be configured to interact with one or more virtual objects in the virtual environment. Further, the processor may be configured to generate a service token indicating service provider access information for the digital entity in the virtual environment. The service token may comprise multiple token parameters indicating characteristics of the digital entity in the virtual environment. The processor may be configured to enable access to at least one service with the service provider via the service token; enable access to at least one service with the service provider via the service token; share the access to the at least one service with the digital entity; monitor a value of a token parameter associated with the digital entity in the virtual environment; and in response to determining that the value of the token parameter is outside a predefined threshold range, disable the access to the at least one service in the service provider via the service token.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrates an example perspective view of a user device operating in the system of FIG. 1 in accordance with one or more embodiments;

FIG. 3 illustrate an example of a connectivity ledger in accordance with one or more embodiments;

FIG. 4 illustrates an example flowchart of a method to share network connectivity in a virtual environment in accordance with one or more embodiments.

### DETAILED DESCRIPTION

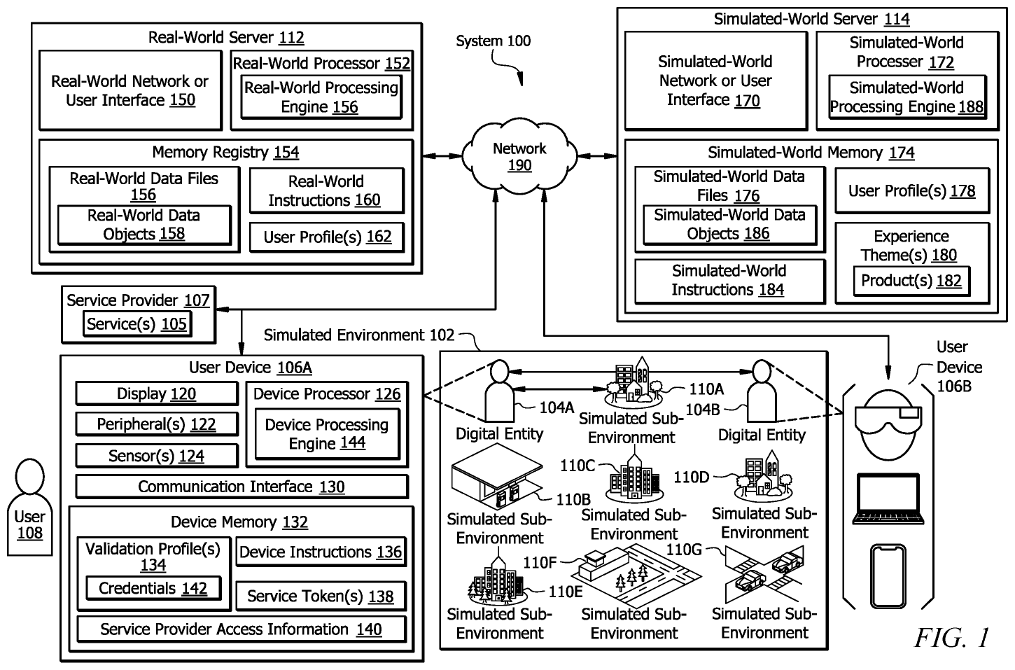

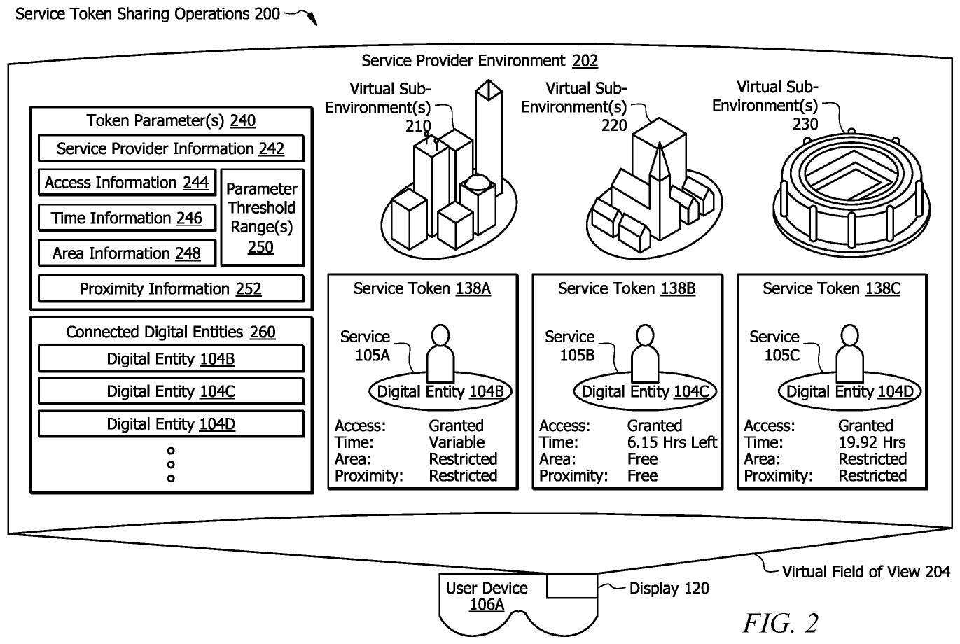

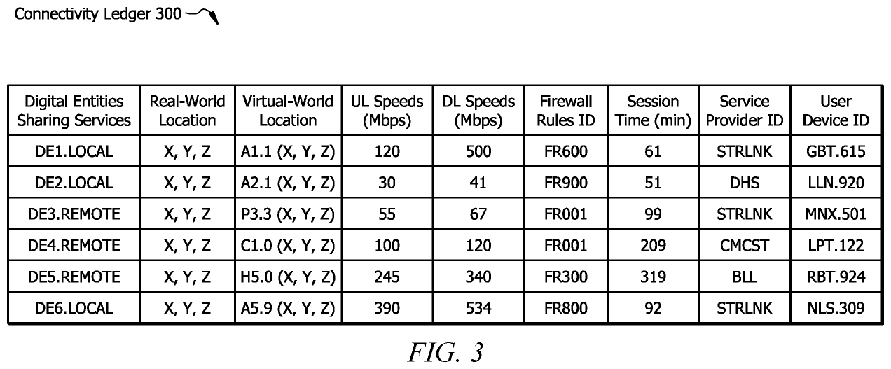

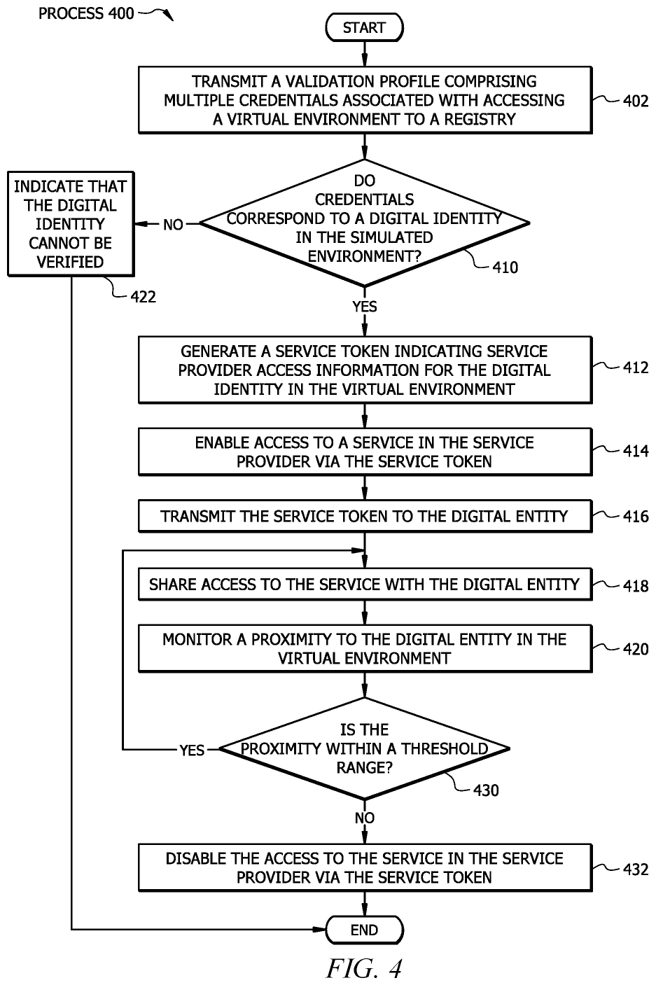

As described above, this disclosure provides various systems and methods to share network connectivity in a simulated (e.g., virtual) environment. In particular, this disclosure provides various systems and methods to slice and assign bandwidth slices (e.g., network resources) to be used between one or more additional user devices and a service provider. FIG. 1 illustrates an example system 100 comprising a virtual environment 102 in which one or more digital entities 104A and 104B (collectively, digital entities 104) are configured to exchange access to one or more services 105 via connections between corresponding user devices 106A and 106B (collectively, user devices 106) and a service provider 107. FIG. 2 illustrates example service token sharing operations 200 performed in a service provider environment 202 by the user device 106A of FIG. 1. FIG. 3 illustrate example connectivity ledger 300 indicating bandwidth allocation shared in the sharing operations 200 of FIG. 2. FIG. 4 illustrates a process 400 to perform one or more of the sharing operations of FIG. 2.

### System Overview

FIG. 1 illustrates an example of a system 100 configured to share network connectivity in the virtual environment 102, in accordance with one or more embodiments. The system 100 comprises a virtual environment 102 in which one or more digital entities 104 may interact with multiple virtual objects. In the virtual environment 102 of FIG. 1, a digital entity 104A may be generated by a user device 106A associated with a user 108 and a digital entity 104B may be generated by a user device 106B. The user device 106A and the user device 106B may interact with one another, with one or more virtual sub-environments 110A-110G in the virtual environment 102, or with one or more virtual objects in any one of the virtual sub-environments 110A-110G. Further, the system 100 comprises a real-world server 112 and a virtual-world server 114 that contribute to the rendering of the virtual objects. In the system 100 of FIG. 1. the user device 106A, the user device 106B, the real-world server 112, and the virtual-world server 114 may be communicatively coupled via one or more connections via a network 180. The system 100 may be operable to transmit data, commands, and information among each one of the user device 106A, the user device 106B, the real-world server 112, and the virtual-world server 114 through the network 180.

In some embodiments, the virtual environment 102 may be a representation of an area or an environment including one or more rendered objects representing virtual reality (VR) or augmented reality (AR) properties to a user (e.g., the user 108) via a user device (e.g., user device 106B). In some embodiments, the VR or AR properties may comprise three-dimensional (3D) or enhanced two-dimensional (2D) images located at a perspective distance from the user (e.g., the user 108). Examples of the virtual environment 102 may be a metaverse environment, a VR-enhanced environment, an AG-enhanced environment, or the like. The virtual environment 102 may comprise a plurality of virtual sub-environments 110A-110G including one or more properties similar to those in the virtual environment 102. In the virtual environment 102 of FIG. 1, the digital entity 104A corresponding to the user device 106A and the digital entity 106B corresponding to the user device 106B may interact with one or more objects rendered in the virtual environment 102 and the virtual sub-environments 110A-110G.

In one or more embodiments, the system 100 may improve interoperability of real-world systems (e.g., comprising real-world server 112) and virtual-world systems (e.g., metaverse systems or comprising the virtual-world server 114) so that information may be seamlessly shared between these systems to implement data security, authorization of data interactions, access to virtual sub-environments (e.g., virtual sub-environments 110A-110G) and other data interactions performed in real-world and virtual environments. For example, user information collected from user-associated devices (e.g., user device 106A, user device 106B, and the like) or assigned to users in a real-world environment may be used in the virtual environment 102 to authenticate the first user 110 before allowing the first user 110 to access the virtual environment 102 and perform any kind of action or interaction within the virtual environment 102. In some embodiments, the user information collected or assigned to user-associated devices (e.g., user device 106A, user device 106B, and the like) in the real-world environment or the virtual environment 102 are used in the virtual environment 102 to provide the user-associated devices (e.g., user device 106A, user device 106B, and the like) access to products or services within the virtual environment 102. In this regard, the system 100 provides improved information security by authenticating that digital entities 104 (e.g., the digital entity 104A or digital entity 104B) are associated with one or more users (e.g., the user 108 for the digital entity 104A and not shown for digital entity 104B) operating corresponding user devices 106 (e.g., user device 106A or user device 106B), not an unauthorized party, authorized to access the virtual environment 102, obtain products and services within the virtual environment 102, and perform data interactions associated with one or more of the virtual sub-environments 110A-110G. In the example of FIG. 1, the system 100 enables the digital entity 104A and the digital entity 104B to obtain a product or a service by transferring real-world data objects between real-world entities based on data interactions performed in the virtual environment 102.

In some embodiments, the system 100 may improve connectivity sharing technologies. In particular, the user devices 106 in the system 100 may be configured to slice up bandwidth allocated for specific device and share one or more bandwidths with any additional user devices 106 in the virtual environment 102. In this regard, any of the user devices 106 may be configured to share access to services (e.g., a portion or a slice of a bandwidth) of the service provider 107 with one or more additional user devices 106.

In one or more embodiments, the terms “real-world” and “real-world environment” in this disclosure refer to any non-virtual environment or non-virtual environment where users (e.g., the user 108 for the digital entity 104A and not shown for digital entity 104B) physically interact with real persons and real objects. A real-world data interaction may refer to any data interaction performed outside the virtual environment 102 (e.g., a transferring an image from the user device 106A to the user device 106B via a connection unrelated to operations comprised in the virtual environment 102). Further, while certain embodiments of this disclosure may be described in the context of a metaverse environment as an example of the virtual environment 102, systems and methods discussed herein apply to any other virtual environment 102. In this regard, the terms “virtual environment” and “metaverse environment” are used interchangeably throughout this disclosure in reference to the virtual environment 102. In addition, while certain embodiments of this disclosure describe one or more operations in relation to the user device 106A and the user 108, these embodiments apply to any other user devices 106 (e.g., user device 106B) or other users (not shown) connected to the network 116.

### System Components

### Service Provider

In one or more embodiments, the service provider 107 comprises one or more services 105. In particular, the service provider may provide connectivity and access to network resources to one or more user devices 106 communicatively coupled to the network 116. In some embodiments, the services 105 may comprise access to the Internet, one or more data processing capabilities, and/or cloud-enabled services (e.g., streaming, real-time information access to server data, and the like). In some embodiments, the service provider 107 may establish a service provider agreement for services 105 with the user 108. In turn, the user 108 may access the services 105 in accordance with one or more rules and policies provided in the agreement. The rules and policies may enable access to the services 105 via service provider access information 140 of the user device 106A.

In one or more embodiments, the rules and policies may enable the user device 106A to separate or divide the services 105 from the service provider 107 and share these fractional services 105 with one or more additional user devices 106 (e.g., user device 106B). For example, the user device 106A may have a service provider agreement with the service provider 107 to access a service 105 in which the user device 106A is allowed to use a bandwidth of 2 gigabytes (GBs) to access cloud-enabled services. In some embodiments, the user device 106A may slice the 2 GB into four slices, each slice comprising 0.5 GBs (e.g., 500 megabytes (MBs)). Then, the user device 106A may share a first slice of 0.5 GB to a first additional user device 106B and a second slice of 0.5 GBs to a second additional user device 106C (shown in FIG. 2) while maintaining two slices of 0.5 GBs in use. In some embodiments, the user device 106A may generate additional slices from an existing slice. In the aforementioned example, the user device 106A may further device a third slice of 0.5 GBs into five separate slices of 0.1 GB (e.g., 100 MBs) and share one of these sub-slices with a third additional user device 106D (shown in FIG. 2).

In one or more embodiments, the rules and policies may enable the user device 106A to generate one or more service tokens 138. The service tokens 138 may indicate access to one or more fractional services 105 divided by the user device 106A. In some embodiments, the service provider 107 may allow the user device 106A to enable or disable the service tokens 138 for a predefined period of time. In other embodiments, the service provider 107 may allow the user device 106A to enable or disable the service tokens 138 dynamically over time. In some embodiments, the service tokens 138 may be generated (e.g., minted) via a decentralized network (not shown) to create Non-Fungible Tokens (NFT) representative of encrypted information. In this regard, decentralized encryption may allow the user device 106A to provide access to the services 105 for any additional user devices 106 without disclosing sensitive information of the user 108.

### User Devices

In one or more embodiments, the user device 106A may comprise one or more users similar to user 108. Further, the user device 106B or any number of additional user devices (not shown) may access the virtual environment 102 at any given time and may comprise one or more electronic components similar to those shown in user device 106A. In some embodiments, the user device 106A, the user device 106B, and any additional user devices (not shown) may be computers, laptops, smartphones, AR devices, VR devices, or any electronic configured to display a representation of the virtual environment 102. As a non-limiting example, the user device 106A comprises a display 120, one or more peripherals 122, one or more sensors 124, a device processor 126, a communication interface 130, and a device memory 132. The device memory 132 comprises one or more validation profiles 134, device instructions 136, one or more service tokens 138, and service provider access information 140. The one or more validation profiles 134 comprise multiple credentials 142. The device processor 126 comprises a device processing engine 144 that, when executing the device instructions 136, causes the device processor 126 to perform one or more operations. In one or more embodiments, the user devices 106 (e.g., the user device 106A and the user device 106B) may be configured as shown, as described below, or in any other suitable configuration. For example, the user device 106A may comprise one or more additional components or one or more shown components may be omitted.

In the example of FIG. 1, the user device 106A may access the virtual environment 102. The user device 106A may be configured to display a two-dimensional (2D) or three-dimensional (3D) representation of the virtual environment 102 in the display 120. Examples of the virtual environment 102 may comprise, but are not limited to, a graphical or virtual representation of a metaverse, a map, a building interior, a landscape, a fictional location, an alternate reality, or any other suitable type of location or environment. The virtual environment 102 may be configured to use realistic or non-realistic physics for the motion of objects within the virtual environment 102. For example, some virtual environments 102 may be configured to use gravity whereas other virtual environments 102 may not be configured to use gravity. Within the virtual environment 102, each user may be associated with a digital entity (e.g., an avatar, a virtual representation, or a virtual representation such as the digital entity 104A associated with the user device 106A for the user 108 and the digital entity 104B associated with the user device 106B). The digital entities 104 (e.g., the digital entity 104A and the digital entity 104B) may be graphical representations of users at a virtual location within the virtual environment 102. In some embodiments, the virtual location of the digital entities 104 may be correlated to the physical location of corresponding users in the real-world environment. Examples of digital entities 104 may comprise, but are not limited to, a person, an animal, or an object. In some embodiments, the features and characteristics of the digital entities 104 may be customizable, and user-defined. For example, sizes, shapes, colors, accessories, or any other suitable type of appearance features associated with attires or appearance of users may be specified by the users. By using digital entities 104, users are able to move within the virtual environment 102 to interact with one or more additional digital entities 104 and objects within the virtual environment 102 while independently remaining at a physical location in the real-world environment or being in movement or transit in the real-world environment.

While engaging in the virtual environment 102 via the digital entities 104, the user devices 106 may interact with a plurality of other users, objects, or entities through a respective digital entity. For example, the user 108 operating the user device 106A may interact with one or more users operating the user device 106B via the digital entity 104A and the digital entity 104B, respectively. In another example, the digital entity 104A of the user device 106A may access a virtual sub-environment 110A within the virtual environment 102 and perform virtual-world data interactions within the virtual sub-environment 110A. In the real-world environment, the user 108 of the user device 106A may be physically located at a distance away from the user device 106B. The user 108 may access the virtual environment 102 through the user device 106A to control the digital entity 104A and attempt to engage in an interaction session with the user device 106B through the digital entity 104B.

Before the interaction between the digital entity 104A and the digital entity 104B occurs or the digital entity 104A may access the virtual sub-environment 110A, the virtual-world server 114 may authenticate that the digital entity 104A is associated with the user 108 and not an unauthorized third-party. For example, the one or more specific users may be required to sign into a secure portal that provides access to a data file (e.g., real-world data files 156 or virtual-world data files 176) associated with the user 108.

In one or more embodiments, each of the user devices 106 (e.g., the user device 106A and the user device 106B) may be any computing device configured to communicate with other devices, such as a server (e.g., real-world server 112 or virtual-world server 114), databases, and the like through the network 116. Each of the user devices 106 may be configured to perform specific functions described herein and interact with one or both of real-world server 112 and the virtual-world server 114 (e.g., via respective user interfaces). Each of the user devices 106 may be hardware that is configured to provide hardware and software resources to one or more users. Examples of user devices 106 comprise, but are not limited to, a virtual reality device, an augmented reality device, a laptop, a computer, a smartphone, a tablet, a smart device, an Internet-of-Things (IoT) device, or any other suitable type of device. The user devices 106 may comprise one or more graphical user interfaces (GUIs) via an image generator display (e.g., the display 120), a touchscreen, a touchpad, multiple keys, multiple buttons, a mouse, or any other suitable type of hardware that allow users to view data and/or to provide inputs into the user devices 106. Each user device may be configured to allow users to send requests to one or both of real-world server 112 and the virtual-world server 114, or to another user device.

In some embodiments, the display 120 is configured to present visual information to the user 108 in the real-world environment. The display 120 may display images representing a VR environment, a virtual reality environment, an AR environment, or mixed reality environment. In other embodiments, the display 120 is configured to present visual information to the user 120 as the virtual environment 102 updated in real-time. The display 120 may be a wearable optical display (e.g., glasses or a head-mounted display (HMD)) configured to reflect projected images and enable the user 108 to see through the display 120. For example, the display 120 may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the display 120 is a graphical display on the user device 106A. For example, the graphical display may be a tablet display or a smartphone display configured to display the virtual environment 102.

In one or more embodiments, the one or more peripherals 122 may comprise audio devices (e.g., speaker, microphones, and the like), input devices (e.g., keyboard, mouse, and the like), or any suitable electronic component that may provide a modifying or triggering input to the user device 106A. For example, the one or more peripherals 122 may be speakers configured to release audio signals (e.g., voice signals or commands) during media playback operations. In another example, the one or more peripherals 122 may be microphones configured to capture audio signals from the user 108. In one or more embodiments, the one or more peripherals 122 may be configured to operate continuously, at predetermined time periods or intervals, or on-demand.

In one or more embodiments, the one or more sensors 124 may comprise multiple internal sensors (e.g., sensors sensing in an inside of the user device 106A) and multiple external sensors (e.g., sensors sensing in an outside of the user device 106A). The one or more sensors 124 may be hardware configured to react to one or more physical stimuli, determine an analog input associated to the stimuli, and provide the device processor 126 with a digital value representative of the analog input. In this regard, the one or more sensors may comprise one or more analog-to-digital converter (ADC) configured to record analog inputs of the physical stimuli and convert the recorded analog inputs into a digital format equivalent value over time. In some embodiments, the internal sensors sample stimuli from inside the user device 106A. For example, the internal sensors may be configured to sense stimuli that may be used to determine an orientation (e.g., a gyroscope), or a velocity (e.g., an accelerometer, the gyroscope, and the like). In some embodiments, the external sensors sample stimuli from outside the user device 106A. For example, the external sensors may be configured to sense stimuli that may be used to determine a geolocation (e.g., a geospatial positioning (GPS) sensor), images surrounding the user device 106A (e.g., image sensors or cameras), a distance of objects surrounding the user device 106A (e.g., depth sensors), or biometrics associated with the user 108 (e.g., biometrics sensors).

As a non-limiting example, the one or more sensors 124 may comprise at least one image sensor or camera. Examples of the one or more cameras may comprise charge-coupled device (CCD) cameras and complementary metal-oxide semiconductor (CMOS) cameras. The image sensors or cameras may be configured to capture images of the user 108. The image sensors or cameras may be configured to capture images continuously, at predetermined time periods or intervals, or on-demand. For example, the image sensors or cameras may be configured to receive a command from the user 108 to capture an image. In another example, the image sensors or cameras may be configured to continuously capture images to form a video stream.

As a non-limiting example, the one or more sensors 124 may comprise a GPS sensor configured to capture and provide geographical location information associated with the user device 106A in relation with a reference point (e.g., a location on Earth). For example, the GPS sensor may be configured to provide a geographic location of the user 108. The GPS sensor may be configured to provide the geographic location information as a relative geographic location or an absolute geographic location. The GPS sensor may provide the geographic location information using geographic coordinates (i.e., longitude and latitude) or any other suitable coordinate system.

As a non-limiting example, the one or more sensors 124 may comprise one or more biometric sensors. Examples of the one or more biometric sensors may comprise retina scanners, fingerprint scanners, and facial scanners. The one or more biometric sensors may be configured to capture information about a person's physical characteristics and output a biometric signal based on captured information. A biometric signal is a signal that is uniquely linked to a person based on their physical characteristics. For example, the one or more biometric sensors may be configured to perform a retinal scan of an eye of the user 108 and generate a biometric signal for the user 108 based on the retinal scan. In another example, one of the biometric sensors may be configured to perform a fingerprint scan of a finger of the user 108 and generate a biometric signal for the user 108 based on the fingerprint scan.

The device processor 126 comprises one or more processors operably coupled to and in signal communication with the display 120, the one or more peripherals 122, the one or more sensors 124, the communication interface 130, and the device memory 132 in the user device 106A. The device processor 126 may be configured to receive and transmit electrical signals among the display 120, the one or more peripherals 122, the one or more sensors 124, the communication interface 130, and the device memory 132. The electrical signals may be used to send and receive data (e.g., images captured from the one or more sensors 124, render virtual objects to display on the display 120, and the like), control, or communicate with servers and other user devices 106. The device processor 126 may be operably coupled to one or more other electronic components (e.g., the real-world server 112 or the virtual-world server 114 shown in FIG. 1).

In one or more embodiments, the service processor 126 is any electronic circuitry comprising state machines, one or more central processing unit (CPU) chips, logic units, cores (e.g., a multi-core processor), field-programmable gate array (FPGAs), application specific integrated circuits (ASICs), or digital signal processors (DSPs). The service processor 126 may be a programmable logic device, a microcontroller, a microprocessor, or any suitable combination of the preceding. The one or more processors may be configured to process data and implemented in hardware or software. For example, the service processor 126 may comprise an 8-bit, a 16-bit, a 32-bit, a 64-bit, or of any other suitable architecture. The service processor 126 may comprise an arithmetic logic unit (ALU) that performs arithmetic and logic operations, processor registers that supply operands to the ALU and store the results of ALU operations, and a control unit that fetches instructions from memory/storage and executes them by directing the coordinated operations of the ALU, registers and other components.

The service processor 126 may comprise a device processing engine 144 that may be hardware configured to execute various instructions (e.g., the device instructions 136 in the device memory 132). For example, the processing engine 144 may be configured to execute one or more instructions of the device instructions 136 that implement one or more operations described herein, such as some or all of those described with respect to FIGS. 1, 2, and 4. For example, the service processor 126 may be configured to display virtual objects on the display 120, detect hand gestures, identify virtual objects selected by a detected hand gesture, capture biometric information of the user 108 as described above, and communicate via the communication interface 130 with the real-world server 112, the virtual-world server 114, or the user device 106B. In some embodiments, the operations described herein are implemented using logic units, FPGAs, ASICs, DSPs, or any other suitable hardware or electronic circuitry as described above.

In one or more embodiments, the communication interface 130 is a user interface or a network interface configured to enable wired and/or wireless communications between the user device 106A and one or more electronic components (e.g., the user device 106B, the real-world server 112, the virtual-world server 114) via the network 116. For example, the communication interface 130 is configured to enable the device processor 126 to transmit and receive signals with these electronic components. The communication interface 130 may be configured to communicate data between the user device 106A and other network devices, systems, or domain(s). For example, the communication interface 130 may comprise a WIFI interface, a Bluetooth interface, a ZigBee interface, an RFID interface, a near field communication interface, a local area network (LAN) interface, a wide area network (WAN) interface, a modem, a switch, or a router. Further, the communication interface 130 is configured to facilitate the device processor 126 in communicating with other electronic components. In some embodiments, the device processor 126 may be configured to send and receive data using the communication interface 130. The communication interface 130 may be configured to use any suitable type of communication protocol to configure, operate, and control transmission and reception of information via the communication interface 130.

In one or more embodiments, the device memory 132 may be configured to store any of the information described with respect to FIGS. 1-4 along with any other data, instructions, logic, rules, or code operable to perform the operations described herein when executed by the device processor 126. For example, the device memory 132 may store the device instructions 136. The device memory 132 comprises one or more disks, tape drives, or solid-state drives, and may be used as an over-flow data storage device, to store programs when such programs are selected for execution, and to store instructions and data that are read during program execution. The device memory 132 may be operable to store, for example, information relating to the identity of the user 108 (e.g., one or more validation profiles 134), one or more device instructions 136 for performing the functions of the user device 106A described herein, one or more service tokens 138 for rendering virtual objects in the virtual environment 102, one or service provider access information 140 for rendering baseline versions of the virtual objects in the virtual environment 102, and any other data or instructions. The device memory 132 may be volatile or non-volatile and may comprise read-only memory (ROM), random-access memory (RAM), ternary content-addressable memory (TCAM), dynamic random-access memory (DRAM), and static random-access memory (SRAM).

In one or more embodiments, the validation profiles 134 are profiles comprising user-associated information. The validation profiles 134 may include one or more user credentials 142 indicating one or more access requests to the virtual environment 102, one or more virtual sub-environments 110A-110G, or multiple operations in the virtual environment 102. The validation profiles 134 may include user-specific access commands or tokens such as usernames with corresponding passwords, passcodes, passphrases, pins, or any string of data that may be confirmed to access the simulation environment 102 or one or more of the virtual sub-environments 110A-110G. In some embodiments, the user credentials 142 indicate information that may be confirmed by the real-world server 112 or the virtual-world server 114 to access the digital entity 104A. For example, a validation profile of the one or more validation profiles 134 may provide one or more credentials 142 to access the digital entity 104A at a predetermined virtual location in the virtual environment 102 (e.g., the virtual sub-environments 110A-110G).

In one or more embodiments, the virtual sub-environments 110A-110 may be a designated region within the virtual environment 102 for use by a given user (e.g., the user 108 for the user device 106A or one or more users for the user device 106B), an entity, or an organization. For example, a virtual sub environment 110B may be assigned to a particular entity which may provide one or more services to users of the virtual environment 102. The virtual sub-environment 110B may take any form in the virtual environment 102 including, but not limited to, a virtual room, a virtual building or portions thereof, a virtual store, or any other designated virtual space/region within the virtual environment 102. The virtual-world server 114 may be configured to generate virtual sub-environments 110A-110G with the virtual environment 102. The virtual sub-environments 110A-110G may be generated for a customized purpose. For example, a virtual sub-environment 110C may be used by an entity that is assigned the virtual sub-environment 110C for receiving virtual-world data objects 186 from users for storing in the virtual-world data files 176 or for distribution to specified one or more target entities. In another example, a virtual sub-environment 110D may allow users (e.g., the user 108) of the virtual environment 102 to perform virtual-world data interactions including transferring virtual-world data objects 186 to other users (e.g., not shown user of the user device 106B) and/or one or more target entities.

In one or more embodiments, the virtual-world server 114 may be configured to generate customized virtual sub-environments 110E-110G to provide customized virtual experiences to users that meet a predetermined criteria or include specific credentials 142 in their corresponding validation profiles 134. For example, the virtual-world server 114 may be configured to generate the virtual sub-environment 110E as a virtual educational location in which the user 108 may interact with digital entities 104 of students and professors attending lectures or lessons and virtual objects representing books, desks, whiteboards, and the like. In another example, the virtual-world server 114 may be configured to generate the virtual sub-environment 110F as a virtual concert venue outdoor location in which the user 108 may interact with digital entities 104 of other concert goers and virtual objects representing seats, access lines, and the like. In yet another example, the virtual-world server 114 may be configured to generate the virtual sub-environment 110F as a virtual road or track in which the user 108 may interact with digital entities 104 of other users driving or observing the drivers and virtual objects representing motor vehicles, control dashboards, street signs, and the like.

As described above, the user 108 may access the services 105 of the service provider 107 in accordance with one or more rules and policies provided in the agreement. The rules and policies may enable access to the services 105 via service provider access information 140 of the device memory 132. In one or more embodiments, the device processor 126 may retrieve the service provider access information 140 to separate or divide the services 105 from the service provider 107 and share these fractional services 105 with one or more additional user devices 106 (e.g., user device 106B). The service provider access information 140 may be configuration parameters to access the services 105 of the service provider 107.

In one or more embodiments, the service tokens 138 may indicate access to one or more fractional services 105 divided by the user device 106A. In some embodiments, the service provider 107 may allow the user device 106A to enable or disable the service tokens 138 for a predefined period of time. In other embodiments, the service provider 107 may allow the user device 106A to enable or disable the service tokens 138 dynamically over time. In some embodiments, the service tokens 138 may be generated (e.g., minted) via a decentralized network (not shown) to create Non-Fungible Tokens (NFT) representative of encrypted information. In this regard, decentralized encryption provides access to the services 105 for any additional user devices 106 without disclosing sensitive information of the user 108.

### Servers

In one or more embodiments, the system 100 comprises a real-world server 112 having a physical location in the real world. The real-world server 112 comprises a real-world network or user interface 150, a real-world processor 152, and a memory registry 154. The memory registry 154 comprises real-world data files 156, real-world instructions 160, and one or more real-world user profiles 162. The real-world data files 156 comprises real-world data objects 158. The real-world processor 152 comprises a device processing engine 144 that, when executing the real-world instructions 160, causes the real-world processor 152 to perform one or more operations.

In some embodiments, the real-world processor 152 comprises one or more processors operably coupled to and in signal communication with the memory registry 154. The real-world processor 152 may be any electronic circuitry including, but not limited to, state machines, one or more CPU chips, logic units, cores (e.g., a multi-core processor), FPGAs, ASICs, or DSPs. The real-world processor 152 may be a programmable logic device, a microcontroller, a microprocessor, or any suitable combination of the preceding. The one or more processors may be configured to process data implemented in hardware or software. For example, the real-world processor 152 may comprise an 8-bit, a 16-bit, a 32-bit, a 64-bit, or of any other suitable architecture. The real-world processor 152 may include an ALU for performing arithmetic and logic operations, processor registers that supply operands to the ALU and store the results of ALU operations, and a control unit that fetches instructions from memory and executes them by directing the coordinated operations of the ALU, registers, and other components.

In the real-world processor 152, one or more processors may be configured to implement or execute the real-world instructions 160. For example, the one or more processors may be configured to execute the real-world instructions 160 to implement one or more operations associated with the real-world server 112. In this regard, the real-world processor 152 may be a special-purpose computer designed to implement the operations described in reference to FIGS. 1-4. In one or more embodiments, the real-world server 112 is implemented using logic units, FPGAs, ASICs, DSPs, or any other suitable hardware. The real-world server 112 is configured to operate as described with reference to FIGS. 1-4. For example, the real-world processor 152 may be configured to perform at least a portion of the process 400 described in reference to FIG. 4.

In one or more embodiments, the real-world network or user interface 150 is configured to enable wired and/or wireless communications. The real-world network or user interface 150 may be configured to communicate data between the real-world server 112 and other devices, systems, or domains (e.g., the user device 106A, the user-device 106B, and the virtual-world server 114). For example, the real-world network or user interface 150 may comprise a Wi-Fi interface, a LAN interface, a WAN interface, a modem, a switch, or a router. The real-world processor 152 may be configured to use any suitable type of communication protocol to send and receive data using the real-world network or user interface 150.

The memory registry 154 comprises one or more disks, tape drives, or solid-state drives, and may be used as an over-flow data storage device, to store programs when such programs are selected for execution, and to store instructions and data that are read during program execution. The memory registry 154 may be volatile or non-volatile and may comprise a ROM, a RAM, a TCAM, a DRAM, and a SRAM. The memory registry 154 is operable to store information relating to the real-world data files 156, the real-world data objects 158, the real-world server instructions 160, and the real-world user profiles 162. The real-world server instructions 160 may include any suitable set of instructions, logic, rules, or code operable to execute operations by the real-world server 112.

In one or more embodiments, the system 100 comprises a virtual-world server 114 having a virtual location in the virtual environment 102. The virtual-world server 114 comprises a virtual-world network or user interface 170, a virtual-world processor 172, and a virtual-world memory 174. The virtual-world memory 174 comprises virtual-world data files 176, one or more virtual-world user profiles 178, one or more experience themes 180 offering one or more products 182, and virtual-world instructions 184. The virtual-world data files 176 comprise virtual-world data objects 186. The virtual-world processor 172 comprises a virtual-world processing engine 188 that, when executing the virtual-world instructions 184, causes the virtual-world processor 172 to perform one or more operations.

In some embodiments, the virtual-world processor 172 comprises one or more processors operably coupled to and in signal communication with the virtual-world memory 174. The virtual-world processor 172 may be any electronic circuitry including, but not limited to, state machines, one or more CPU chips, logic units, cores (e.g., a multi-core processor), FPGAs, ASICs, or DSPs. The virtual-world processor 172 may be a programmable logic device, a microcontroller, a microprocessor, or any suitable combination of the preceding. The one or more processors may be configured to process data implemented in hardware or software. For example, the virtual-world processor 172 may comprise an 8-bit, a 16-bit, a 32-bit, a 64-bit, or of any other suitable architecture. The virtual-world processor 172 may include an ALU for performing arithmetic and logic operations, processor registers that supply operands to the ALU and store the results of ALU operations, and a control unit that fetches instructions from memory and executes them by directing the coordinated operations of the ALU, registers, and other components.

In the virtual-world processor 172, one or more processors may be configured to implement or execute the virtual-world instructions 184. For example, the one or more processors may be configured to execute the virtual-world instructions 184 to implement one or more operations associated with the virtual-world server 114. In this regard, the real-world processor 152 may be a special-purpose computer designed to implement the operations described in reference to FIGS. 1-4. In one or more embodiments, the virtual-world server 114 is implemented using logic units, FPGAs, ASICs, DSPs, or any other suitable hardware. The virtual-world server 114 is configured to operate as described with reference to FIGS. 1-4. For example, the virtual-world processor 172 may be configured to perform at least a portion of the process 400 described in reference to FIG. 4.

In one or more embodiments, the virtual-world network or user interface 170 is configured to enable wired and/or wireless communications. The virtual-world network or user interface 170 may be configured to communicate data between the virtual-world server 114 and other devices, systems, or domains (e.g., the user device 106A, the user-device 106B, and the real-world server 112). For example, the virtual-world network or user interface 170 may comprise a Wi-Fi interface, a LAN interface, a WAN interface, a modem, a switch, or a router. The virtual-world processor 172 may be configured to use any suitable type of communication protocol to send and receive data using the virtual-world network or user interface 170.

The virtual-world memory 174 comprises one or more disks, tape drives, or solid-state drives, and may be used as an over-flow data storage device, to store programs when such programs are selected for execution, and to store instructions and data that are read during program execution. The virtual-world memory 174 may be volatile or non-volatile and may comprise a ROM, a RAM, a TCAM, a DRAM, and a SRAM. The virtual-world memory 174 is operable to store information relating to the virtual-world data files 176, the virtual-world data objects 186, the virtual-world instructions 184, the virtual-world user profiles 178, the one or more experience themes 180, and the one or more products 182. The virtual-world server instructions 184 may include any suitable set of instructions, logic, rules, or code operable to execute operations by the virtual-world server 114.

In one or more embodiments, the virtual-world server 114 may be configured to facilitate a user (e.g., the user 108) to obtain one or more products 182 in the virtual environment 102 or the real-world environment. As shown in FIG. 1, the virtual-world server 114 may be configured to store one or more experience themes 180, where each experience theme 180 relates to a particular type of experience that may be experienced by the user 108 in the virtual environment 102 or the real-world environment. An example of the experience themes 180 associated with the virtual environment 102 may include visual elements that make up the virtual environment 102 (i.e., a concert going experience, a travel experience, and the like). Each of the one or more experience themes 180 comprises one or more product types with multiple products 182 that relate to a given experience theme. For example, an experience theme of the experience themes 180 may relate to a visual experience of the user 108 within the virtual environment 102. In this experience theme, multiple corresponding product types may comprise appearance modifications (e.g., changes to an avatar or attire related to the digital entity 104A), buildings, roads, objects, colors, or patterns. In another example, an experience theme of the experience themes 180 may relate to a travel experience in the real-world environment. In this experience theme, multiple corresponding product types may comprise real-world access to rental cars, bus rides, train passes, travel destination entertainment, hotel stays, restaurants, and excursions. Each of the experience themes 180 may comprise several products 182 associated with each product type. For example, when a specific experience theme of the experience themes 180 relates to a visual experience within the virtual environment 102, the “appearance modifications” product type may include several specific avatars that may be used by the digital entity 104A within the virtual environment 102. The “buildings” product type may include multiple specific virtual buildings that may be used to generate the virtual environment 102. The “colors” and “patterns” product types may respectively comprise multiple colors or patterns that may be used to render specific virtual objects or portions of the virtual environment 102.

In one or more embodiments, once one of the products 182 are selected by the user 108.

the virtual-world server 114 may be configured to determine one or more data files (e.g., real-world data files 156 or virtual-world data files 176) that may be used to obtain at least one of the products 182 selected by the user 108. In this context, the virtual-world server 114 may be configured to store information relating to multiple real-world data files 156 and virtual-world data files 176 that may be used by the user 108 to obtain one or more of the products 182 associated with one or more experience themes 180. A particular product of the products 182 may be obtained by the user 108 by transferring a predetermined amount of real-world data objects 158 from a real-world data file of the real-world data files 156 registered to the user 108 to another real-world data file of the real-world data files 156 registered to an entity that provides the particular product, or by transferring a predefined amount of virtual-world data objects 186 from a virtual-world data file of the virtual-world data files 176 registered to the user 108 to another virtual-world data file of the virtual-world data files 176 registered to an entity that provides the particular product.

In some embodiments, a single data file (e.g., one of the real-world data files 156 or virtual-world data files 176) may be used to obtain multiple products 182. In some embodiments, any one of multiple data files (e.g., one of the real-world data files 156 or virtual-world data files 176, or combinations thereof) may be used to obtain a same product of the products 182.

Each of the real-world server 112 and the virtual-world server 114 may be a suitable server (e.g., including a physical server or virtual server) operable to store data in a memory (e.g., memory registry 154 or virtual-world memory 174) or provide access to one or more applications or other services. One or both of the real-world server 112 and the virtual-world server 114 may be a backend server associated with a particular entity (e.g., an organization) that facilitates conducting data interactions between particular entities, between one or more users, or between a user and a particular entity. In other embodiments, one or both of the real-world server 112 and the virtual-world server 114 may be organized in a distributed manner, or by leveraging cloud computing technologies. The real-world server 112 may store information which is primarily used to support data interactions performed in the real-world environment. The virtual-world server 114 may store information which is primarily used to support data interactions performed in the virtual environment 102 (e.g., a metaverse data interactions performed in a metaverse environment). In one or more embodiments, the real-world server 112 and the virtual-world server 114 may be implemented by a single server.

As shown in FIG. 1, real-world data files 156 of the user 108 are stored and managed by the real-world server 112 and the virtual-world data files 176 of the user 108 is stored and managed by the virtual-world server 114. In one or more embodiments, the real-world server 112 may employ single sign-on (SSO), multifactor authentication, or any other suitable authentication scheme in order to allow the user 108 access to the real-world data files 156. Similarly, the virtual-world server 112 may employ SSO, multifactor authentication, or any other suitable authentication scheme in order to allow the user 108 access to the virtual-world data files 176. The real-world data files 156 and the virtual-world data files 176 may comprise the real-world data objects 158 and the virtual-world data objects 186, respectively. The real-world data files 156 and the virtual-world data files 176 may be associated to or owned by the user 108. The real-world server 112 and the virtual-world server 114 may store other information related to the user 108 comprising user profile information, account information (e.g., including access to digital identity such as the digital entity 104A and the digital entity 104B and other details relating to the real-world data objects 158 and the virtual-world data objects 186), avatar information, digital assets (e.g., respective real-world data objects 158 and virtual-world data objects 186) information, or any other suitable type of information that is associated with a user within the real-world environment or the virtual environment 102.

Information relating to the virtual-world data file of the virtual-world data files 176 of the user 108 may be stored by the virtual-world server 114 as part of the virtual-world user profiles 178 of the user 108 stored at the virtual-world server 114. The information may comprise an identity of the virtual-world data file, an amount of the virtual-world data objects 186 stored in the virtual-world data files 176, a log of virtual-world data interactions conducted in the virtual environment 102 in relation to the virtual-world data files 176 and any other information relating to the virtual-world data files 176. As described below, the information relating to the virtual-world data files 176 of the user 108 may further include a benefit count associated with the virtual-world data files 176.

### Network

In the example system 100 of FIG. 1, the user device 106A, the user device 106B, the service provider 107, the real-world server 112, and the virtual-world server 160 are communicatively coupled to one another via wired or wireless connections in a network 112. The network 112 may facilitate communication within the system 100. This disclosure contemplates that the network 112 may be any suitable network operable to facilitate communication between the user device 106A, the user device 106B, the service provider 107, the real-world server 112, and the virtual-world server 114. The network 112 may include any interconnecting system capable of transmitting audio, video, signals, data, messages, or any combination of the preceding. The network 112 may include all or a portion of a LAN, a WAN, an overlay network, a software-defined network (SDN), a virtual private network (VPN), a packet data network (e.g., the Internet), a mobile telephone network (e.g., cellular networks, such as 4G or 5G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the system 100. In other embodiments, the system 100 may not have all of these components or may comprise other elements instead of, or in addition to, those above.

### Operational Flow Overview

### Validation of a Digital Entity

In the example of FIG. 1, the user device 106A may be configured to share network connectivity in the virtual environment 102. The user device 106A may be configured to receive requests from one or more digital entities 104 in the virtual environment 102. The requests may be to obtain one or more services 105 from the service provider 107. The user device 106A may parse each request and retrieve a validation profile (e.g., one of the validation profiles 134) associated with each of the one or more digital entities 104. The user device 106A may determine whether a specific validation profile 134 is sufficient to confirm an identity of a specific user device 106.

### Providing Service Tokens

Upon confirming the identity of a given user device 104B, the user device 106A may generate service token 138A (shown in FIG. 2) indicating a service provider information 242 to the digital entity 104B in the virtual environment 102. The digital entity 104B may use the service provider information 242 to access the service 105 from the service provider 107. In some embodiments, the service 105 may comprise a new bandwidth allocation and a new connection speed between the user device 106B associated with the digital entity 104B in the real world. In this regard, the service provider information 242 enables the user device 106B associated with the digital entity 104B to use the service provider 107 to access the service 105 specified in the service token 138A.

### Control Service Token Use

In other embodiments, the service token 138A may include multiple token parameters 240 that act as restrictions to the access of the service 105. The service tokens 138 may be enabled to provide access to one or more services 105 as long as one or more of the token parameters 240 are matched within a predefined threshold range. The token parameters are described in reference to FIG. 2.

### Service Token Sharing Operations

FIG. 2 illustrates service token sharing operations 200, in accordance with one or more embodiments. In the example of FIG. 2, the service token sharing operations 200 is shown as being performed in a perspective view of the user device 106A presented in the display 120. In other embodiments, the service token sharing operations 200 may be performed by the user device 106A in the background and without presenting any operations of the analysis in the display 120. The user device 106A comprises a virtual field of view 204 in which the user 108 may view the service provider environment 202 as part of the virtual environment 102. In the virtual field of view 204, the service provider environment 202 may comprise one or more service tokens 138 assigned to one or more digital entities 104. In some embodiments, the service provider environment 202 indicates one or more virtual-sub-environments 210-230 that the digital entities 104 are allowed to access via the service tokens 138. In some embodiments, the service provider environment 202 shows one or more token parameters 240. Each of the service token 138 may comprise one or more of the token parameters 240. In other embodiments, the token parameters 240 comprise service provider information 242, access information 244, time information 246, area information 248, one or more parameter threshold ranges 250, and proximity information 252. The service provider environment 202 may comprise one or more connected digital entities 260 listing all or a portion of the digital entities associated with service tokens 138.

In one or more embodiments, the token parameters 240 may be configured by the user device 106A in accordance with the service provider access information 140. The token parameters 240 may be configuration parameters that provide restrictions to the digital entities 104 using the service tokens 138. In some embodiments, the service provider information 242 indicates instructions and configurations to access the services 105 from the service provider 107. The access information 244 may represent a restriction to access specific service providers in a given service token 138. If the access information 244 is provided, the digital entities 104 may use the given service token 138. If the access information 244 is not provided, the digital entities 104 may not use the given service token 138. In the service tokens 138, the access information 244 may have a “GRANTED” status that grants the connected digital entities 260 access to the services 105 or a “DENIED” status that denies the connected digital entities 260 access to the services 105. The time information 246 may represent a restriction to use a given service token 138 for a predefined time period. The time information 246 may provide a status indicating that time is “VARIABLE” in cases where the user device 106A provides usage of the service tokens 138 without a time restriction. The time information 246 may provide a status indicating the time that has lapsed or the time left in the use of a service token 138. The area information 248 may represent a restriction to use a given service token 138 in a given area in the virtual environment 102. The area information 248 may restrict the digital entities to remain within a predefined area in a virtual sub-environment. In the service tokens 138, this restriction may comprise a label of “RESTRICTED” in cases that that free roaming is restricted to a specific area or “FREE” in cases that the area is not restricted (e.g., free roaming in different areas may be allowed). The proximity information 252 may represent a restriction to use a given service token 138 in a given session in the virtual environment 102. The proximity information 252 may indicate that the digital entity 104B is restricted to use the service token 138 as long as the digital entity 104B is within a predefined distance from the digital entity 106A in the virtual environment 102. The In the service tokens 138, this restriction may comprise a label of “RESTRICTED” in cases that that free roaming is restricted to a specific session or “FREE” in cases that the session is not restricted (e.g., free roaming in different sessions may be allowed).

In some embodiments, the one or more parameter threshold ranges 250 are threshold ranges indicating tolerance values from which the restrictions may be triggered. In this regard, the user device 106A may dynamically or periodically modify the parameter threshold ranges 250 such that the service tokens 138 may be individually or collectively enabled or disabled.

In the example of FIG. 3, the service provider environment 202 indicates one or more virtual-sub-environments 210 that the digital entity 104B is allowed to access using the service token 138A to connect to a service 105A; one or more virtual-sub-environments 220 that the digital entity 104C is allowed to access using the service token 138B to connect to a service 105B; and one or more virtual-sub-environments 230 that the digital entity 104D is allowed to access using the service token 138C to connect to a service 105C.

Under the service token 138A, the digital entity 104B is shown to have a “GRANTED” status for the access information 244 (e.g., “ACCESS”), a “VARIABLE” status for the time information 246 (e.g., “TIME”), a “RESTRICTED” status for the area information 248 (e.g., “AREA”), and a “RESTRICTED” status for the proximity information 252 (e.g., “PROXIMITY”). Under the service token 138B, the digital entity 104C is shown to have a “GRANTED” status for the access information 244, a “6.15 HRS LEFT” status for the time information 246, a “FREE” status for the area information 248, and a “FREE” status for the proximity information 252. Under the service token 138C, the digital entity 104C is shown to have a “GRANTED” status for the access information 244, a “19.92 HRS” status for the time information 246, a “RESTRICTED” status for the area information 248, and a “RESTRICTED” status for the proximity information 252.

In one or more embodiments, the digital entity 106B may request a change to one or more of the token parameters 240. In turn the user device 106 may indicate via the digital entity 106A whether a request is approved or denied.

### Example Property Comparisons

FIG. 3 illustrates a connectivity ledger 300 in accordance with one or more embodiments. In the example of FIG. 3, the connectivity ledger 300 may be a ledger relating one or more user devices 106 with a corresponding fractional service 105. For example, the connectivity ledger 300 may indicate that a specific user device 106 is allowed a certain bandwidth slice in accordance with a corresponding service token 138. The connectivity ledger 300 may comprise digital entities sharing services indicative of connected digital entities 260 of FIG. 2, corresponding real-world location for each of the connected digital entities 260, corresponding virtual-world location for each of the connected digital entities 260, corresponding upload (UL) speeds, corresponding download (DL) speeds, corresponding firewall rules identifiers (IDs), corresponding session times, corresponding service provider IDs, and corresponding user device IDs. For example, a first digital entity 104B connecting to the services 205 via a first service token 138 may be included in the digital entities sharing services as DE1.LOCAL.

In one or more embodiments, the digital entities sharing services may indicate whether the associated connected digital entity 260 is at a predefined local proximity (e.g., within the proximity threshold range) from the digital entity 104A or at a predefined remote proximity (e.g., out of the proximity threshold range) from the digital entity 104A. In the example of FIG. 3, the connected digital entities 260 are indicated to be within the proximity threshold range or out of the proximity threshold range in accordance with the extension “.LOCAL” or “.REMOTE,” respectively. The real-world locations may be coordinates or reference directions on Earth. The virtual-world location may be coordinates or reference directions on the virtual environment 102. In some embodiments, the UL speeds may be data processing speeds to perform UL data transmissions to the network 116 depicted in megabits per second (Mbps). The DL speeds may be data processing speeds to perform DL data transmissions from the network 116 depicted in Mbps. In some embodiments, the firewall rules ID references rules and policies to protect the services 105 provided via each of the service tokens 138. In other embodiments, the session time may be a time limit or a time duration associated with the use of the service tokens 138 shown in minutes (min). The service provider IDs reference one or more service providers 107 which the user device 106A is entitled to access. Further, the user device IDs may be labels assigned to each of the connected digital entities 260.

### Example Process

FIG. 4 illustrates an example flowchart of a process 400 to share network connectivity (e.g., bandwidth slices or access to services) in the virtual environment 104, in accordance with one or more embodiments. Modifications, additions, or omissions may be made to the process 400. The process 400 may include more, fewer, or other operations than those shown below. For example, operations may be performed in parallel or in any suitable order. While at times discussed as the real-world server 112, the virtual-world server 114, the user devices 106, or components of any of thereof performing operations described in the operations, any suitable system or components of the system 100 may perform one or more operations of the process 400. For example, one or more operations of process 400 may be implemented, at least in part, in the form of real-world instructions 160, the virtual-world instructions 184, or the device instructions 136 of FIG. 1, stored on non-transitory, tangible, machine-readable media (e.g., the memory registry 154, the virtual-world memory 174, or the device memory 132 of FIG. 1) that when run by one or more processors (e.g., the real-world processor 152, the virtual-world processor 172, or the device processor 126 of FIG. 1) may cause the one or more processors to perform operations described in operations 402-432.

The process 400 starts at operation 402, where the user device 106A transmits a validation profile (e.g., of the one or more validation profiles 134) comprising multiple credentials 142 associated with accessing the virtual environment 102 to the memory registry 154. In some embodiments, the user device 106A transmits the validation profile to the virtual-world memory 174. At the memory registry 154 or the virtual-world memory 174, the credentials 142 may be validated or registered to start an access process in which the user device 106A confirms that the user device 106B may access one or more service tokens 138 in the virtual environment 102.

The process 400 continues at operation 410, where the server determines whether the credentials 142 correspond to the digital entity 104B in the virtual environment 102. If the credentials 142 are associated with the digital entity 104B (e.g., YES), the process 400 proceeds to operation 412. If the credentials are not associated with the digital entity 104B (e.g., NO), the process 400 proceeds to operation 422. At operation 422, the user device 106A loses access to the virtual environment 102. In one or more embodiments, if the credentials 142 are not matched such that the validation profile cannot be found in the real-world user profiles 162 or the virtual-world user profiles 178, the user device 106B may be held from accessing the services 105 via the digital entity 104B.

At operation 412, the user device 106A generates a service token 138A indicating service provider access information 140 for the digital entity 104B in the virtual environment 102. At operation 414, the user device 106A enables access to a service 105 in the service provider 107 via the service token 138A. In this regard, the user device 106A may provide one or more token parameters 240 enabling access to the service 105 and one or more usage restrictions. At operation 416, the user device 106A transmits the service token 138A to the digital entity 104B. At operation 418, the user device 106A shares access to the service 105 with the digital entity 104A. The user device 106A may be notified that the user device 106B uses the service 105 via the service token 138. At operation 420, the user device 106A monitors a proximity to the digital entity in the virtual environment 102. The proximity may be one of the proximity information 252 of the token parameters 240 of FIG. 2. As described in reference to FIGS. 1 and 2, the service token sharing operations 200 comprise dynamically, continuously, or periodically the connected digital entities 260 are within a threshold range of the token parameters 240 established by the user device 106A.

The process 400 continues at operation 430, where the user device 106A determines whether the proximity is within the corresponding parameter threshold range 250. In one or more embodiments, if the user device 106A determines that the proximity is within the corresponding parameter threshold range 250 (e.g., YES), the process returns to operation 418 where the user device 106A maintains sharing the access to the service 105 with the digital entity 106A. If the user device 106A determines that the proximity is outside the corresponding parameter threshold range 250 (e.g., NO), the process ends at operation 432, where the user device 106A disables the access to the service 105 in the service provider 107 via the service token 138A.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. An apparatus, comprising:
a memory configured to store:
at least one user profile indicating at least one credential associated with accessing a virtual environment; and
service access provider information indicating instructions to access one or more services from a service provider;
a processor communicatively coupled to the memory and configured to:
transmit a validation profile to a registry in which each credential of a plurality of credentials is confirmed as belonging to a digital entity in the virtual environment, the digital entity being configured to interact with one or more virtual objects in the virtual environment;
generate a service token indicating service provider access information for the digital entity in the virtual environment, the service token comprising a plurality of token parameters indicating characteristics of the digital entity in the virtual environment;
enable access to at least one service with the service provider via the service token;
enable access to at least one service with the service provider via the service token;
share the access to the at least one service with the digital entity;
monitor a value of a token parameter associated with the digital entity in the virtual environment; and
in response to determining that the value of the token parameter is outside a predefined threshold range, disable the access to the at least one service in the service provider via the service token.

2. The apparatus of claim 1, wherein:
the plurality of token parameters comprise service provider information, access information, time information, area information, and proximity information;
the service provider information indicates instructions to establish a communication link between the digital entity and the service provider;
the access information indicates instructions for the digital entity to access the at least one service via the communication link;
the time information indicates a time period in which the digital entity accesses the at least one service from the service provider via the service token;
the area information indicates one or more virtual sub-environments of the virtual environment in which the digital entity accesses the at least one service via the service token; and
the proximity information indicates a proximity to the digital entity in the virtual environment.

3. The apparatus of claim 2, the processor is further configured to:
in conjunction with monitoring the value of the token parameter, receive a request from the digital entity in the virtual environment to increase the predefined threshold range, the token parameter being the time information; and
update the service token to indicate an update to the service provider access information for the digital entity in the virtual environment, the update referencing an increase in the time period in which the digital entity accesses the at least one service from the service provider via the service token.

4. The apparatus of claim 2, the processor is further configured to:
in conjunction with monitoring the value of the token parameter, receive a request from the digital entity in the virtual environment to increase the predefined threshold range, the token parameter being the area information; and
update the service token to indicate an update to the service provider access information for the digital entity in the virtual environment, the update referencing an increase in the one or more virtual sub-environments of the virtual environment in which the digital entity accesses the at least one service via the service token.

5. The apparatus of claim 2, the processor is further configured to:
in conjunction with monitoring the value of the token parameter, receive a request from the digital entity in the virtual environment to increase the predefined threshold range, the token parameter being the access information; and
update the service token to indicate an update to the service provider access information for the digital entity in the virtual environment, the update referencing an increase in the instructions for the digital entity to access the at least one service via the communication link.

6. The apparatus of claim 1, further comprising:
a display communicatively coupled to the memory and the processor, configured to:
present at least a portion of the virtual environment to a user; and
in response to the processor determining that the value of the token parameter is outside the predefined threshold range, present an alert to the user in the virtual environment.

7. The apparatus of claim 1, wherein the processor is further configured to:
in conjunction with monitoring the value of the token parameter, monitor a value of an additional token parameter associated with the digital entity in the virtual environment; and
in response to determining that the value of the token parameter is outside the predefined threshold range and that the value of the additional token parameter is outside an additional predefined threshold range, disable the access to the at least one service in the service provider via the service token.

8. The apparatus of claim 1, wherein the processor further configured to:
transmit an additional validation profile to the registry in which each credential of an additional plurality of credentials is confirmed as belonging to an additional digital entity in the virtual environment, the additional digital entity being configured to interact with the one or more virtual objects in the virtual environment;
generate an additional service token indicating additional service provider access information for the additional digital entity in the virtual environment, the additional service token comprising an additional plurality of token parameters indicating characteristics of the additional digital entity in the virtual environment;
enable access to at least one additional service in the service provider via the additional service token;
transmit the additional service token to the additional digital entity in the virtual environment, the additional digital entity accessing the at least one additional service from the service provider via the additional service token;
share the access to the at least one additional service with the digital entity;
monitor a value of an additional token parameter associated with the additional digital entity in the virtual environment; and
in response to determining that the value of the additional token parameter is outside an additional predefined threshold range, disable the access to the at least one additional service in the service provider via the additional service token.

9. A method, comprising:
transmitting a validation profile to a registry, wherein:
the validation profile indicates a plurality of credentials associated with accessing a virtual environment;
at the registry, each credential of the plurality of credentials is confirmed as belonging to a digital entity in the virtual environment; and
the digital entity is configured to interact with one or more virtual objects in the virtual environment;
generating a service token indicating service provider access information for the digital entity in the virtual environment, wherein:
the service access provider information indicates instructions to access one or more services from a service provider; and
the service token comprises a plurality of token parameters indicating characteristics of the digital entity in the virtual environment;
enabling access to at least one service with the service provider via the service token;
transmitting the service token to the digital entity in the virtual environment, the digital entity accessing the at least one service from the service provider via the service token;
sharing the access to the at least one service with the digital entity;
monitoring a value of a token parameter associated with the digital entity in the virtual environment; and
in response to determining that the value of the token parameter is outside a predefined threshold range, disabling the access to the at least one service in the service provider via the service token.

10. The method of claim 9, wherein:
the plurality of token parameters comprise service provider information, access information, time information, area information, and proximity information;
the service provider information indicates instructions to establish a communication link between the digital entity and the service provider;
the access information indicates instructions for the digital entity to access the at least one service via the communication link;
the time information indicates a time period in which the digital entity accesses the at least one service from the service provider via the service token;
the area information indicates one or more virtual sub-environments of the virtual environment in which the digital entity accesses the at least one service via the service token; and
the proximity information indicates a proximity to the digital entity in the virtual environment.

11. The method of claim 10, further comprising:
in conjunction with monitoring the value of the token parameter, receiving a request from the digital entity in the virtual environment to increase the predefined threshold range, the token parameter being the time information; and
updating the service token to indicate an update to the service provider access information for the digital entity in the virtual environment, the update referencing an increase in the time period in which the digital entity accesses the at least one service from the service provider via the service token.

12. The method of claim 10, further comprising:
in conjunction with monitoring the value of the token parameter, receiving a request from the digital entity in the virtual environment to increase the predefined threshold range, the token parameter being the area information; and
updating the service token to indicate an update to the service provider access information for the digital entity in the virtual environment, the update referencing an increase in the one or more virtual sub-environments of the virtual environment in which the digital entity accesses the at least one service via the service token.

13. The method of claim 10, further comprising:
in conjunction with monitoring the value of the token parameter, receiving a request from the digital entity in the virtual environment to increase the predefined threshold range, the token parameter being the access information; and
updating the service token to indicate an update to the service provider access information for the digital entity in the virtual environment, the update referencing an increase in the instructions for the digital entity to access the at least one service via the communication link.

14. The method of claim 9, further comprising:
presenting at least a portion of the virtual environment via a display; and
in response to the processor determining that the value of the token parameter is outside the predefined threshold range, presenting an alert to the user in the virtual environment.

15. The method of claim 9, further comprising:
in conjunction with monitoring the value of the token parameter, monitoring a value of an additional token parameter associated with the digital entity in the virtual environment; and
in response to determining that the value of the token parameter is outside the predefined threshold range and that the value of the additional token parameter is outside an additional predefined threshold range, disabling the access to the at least one service in the service provider via the service token.

16. The method of claim 9, further comprising:
transmitting an additional validation profile to the registry in which each credential of an additional plurality of credentials is confirmed as belonging to an additional digital entity in the virtual environment, the additional digital entity being configured to interact with the one or more virtual objects in the virtual environment;
generating an additional service token indicating additional service provider access information for the additional digital entity in the virtual environment, the additional service token comprising an additional plurality of token parameters indicating characteristics of the additional digital entity in the virtual environment;
enabling access to at least one additional service in the service provider via the additional service token;
transmitting the additional service token to the additional digital entity in the virtual environment, the additional digital entity accessing the at least one additional service from the service provider via the additional service token;
sharing the access to the at least one additional service with the digital entity;
monitor a value of an additional token parameter associated with the additional digital entity in the virtual environment; and
in response to determining that the value of the additional token parameter is outside an additional predefined threshold range, disabling the access to the at least one additional service in the service provider via the additional service token.

17. A non-transitory computer readable medium storing instructions that when executed by a processor cause the processor to:
transmit a validation profile to a registry, wherein:
the validation profile indicates a plurality of credentials associated with accessing a virtual environment;
at the registry, each credential of the plurality of credentials is confirmed as belonging to a digital entity in the virtual environment; and
the digital entity is configured to interact with one or more virtual objects in the virtual environment;
generate a service token indicating service provider access information for the digital entity in the virtual environment, wherein:
the service access provider information indicates instructions to access one or more services from a service provider; and
the service token comprises a plurality of token parameters indicating characteristics of the digital entity in the virtual environment;
enable access to at least one service with the service provider via the service token;
transmit the service token to the digital entity in the virtual environment, the digital entity accessing the at least one service from the service provider via the service token;
share the access to the at least one service with the digital entity;
monitor a value of a token parameter associated with the digital entity in the virtual environment; and
in response to determining that the value of the token parameter is outside a predefined threshold range, disable the access to the at least one service in the service provider via the service token.

18. The non-transitory computer readable medium of claim 17, wherein:
the plurality of token parameters comprise service provider information, access information, time information, area information, and proximity information;
the service provider information indicates instructions to establish a communication link between the digital entity and the service provider;
the access information indicates instructions for the digital entity to access the at least one service via the communication link;
the time information indicates a time period in which the digital entity accesses the at least one service from the service provider via the service token;
the area information indicates one or more virtual sub-environments of the virtual environment in which the digital entity accesses the at least one service via the service token;
and the proximity information indicates a proximity to the digital entity in the virtual environment.

19. The non-transitory computer readable medium of claim 18, wherein the instructions further cause the processor to:
in conjunction with monitoring the value of the token parameter, receive a request from the digital entity in the virtual environment to increase the predefined threshold range, the token parameter being the time information; and
update the service token to indicate an update to the service provider access information for the digital entity in the virtual environment, the update referencing an increase in the time period in which the digital entity accesses the at least one service from the service provider via the service token.

20. The non-transitory computer readable medium of claim 18, wherein the instructions further cause the processor to:
in conjunction with monitoring the value of the token parameter, receive a request from the digital entity in the virtual environment to increase the predefined threshold range, the token parameter being the area information; and
update the service token to indicate an update to the service provider access information for the digital entity in the virtual environment, the update referencing an increase in the one or more virtual sub-environments of the virtual environment in which the digital entity accesses the at least one service via the service token.
